(19) United States
(12) Patent Application Publication
(10) Pub. No.: US 2006/0278050 A1
(43) Pub. Date: Dec. 14, 2006

(54) Holding chuck for fastening tools

(76) Inventor: Fu-Jen Hsiao, Taichung County (TW)

Correspondence Address: BIRCH STEWART KOLASCH & BIRCH, PO BOX 747, FALLS CHURCH, VA, 22040-0747, US

(21) Appl. No.: 11/149,268

(22) Filed: Jun. 10, 2005

(51) Int. Cl. B25B 23/10; B25B 13/02; B25B 23/08

(52) U.S. Cl. 81/451; 81/125; 81/452

(57) ABSTRACT

A holding chuck for fastening tools includes a spindle in the center that has one end coupling with a fastening tool to receive a rotational driving force and another end coupling with a screw head of a screw to perform fastening or unfastening. The spindle is coupled with a hollow holding member on the periphery. The holding member has an indented dome on the bottom to magnetically attract the screw head. The dome has an annular wall with a plurality of wedge elements wedged therein. The wedge elements are confined by an elastic ring on the outside. Thus the holding chuck can hold magnetic and non-magnetic screws.

### FIELD OF THE INVENTION

The present invention relates to a holding chuck for fastening or unfastening screws and particularly to a holding chuck for holding screws made of magnetic and non-magnetic materials.

### BACKGROUND OF THE INVENTION

The general pneumatic tools for fastening (or unfastening) screws as the one shown in FIGS. 1 and 2 usually have a holding chuck 1 to hold the screw head 3 of a screw 2. The holding chuck 1 has a hexagonal spindle 4 in the center with a first end coupled with a pneumatic tool to transmit rotational driving power. The spindle 4 has a cross-shaped coupling section 5 on a second end mating and engageable with a plum-shaped notch 6 formed on the screw head 3. Hence when the spindle 4 rotates, the screw 2 is driven and rotated for fastening or unfastening.

While the spindle 4 rotates, it is easily separated from the notch 6 of the screw head 3. To re-couple the notch 6 to fasten or unfasten the screw 2 again, rotation of the spindle 4 has to be stopped completely. Moreover, the coupling section 5 is surrounded by an annular holding member 7 which has a hollow dome on the bottom. The hollow dome has a magnetic inner top wall 8 formed in a shape to mate and attract the screw head 3 of the screw 2 made of ferrous materials or the like. Hence while the spindle 4 rotates, the screw 2 may be held by the coupling section 5 of the spindle 4 without escaping.

However, there are many screws made from non-magnetic materials and cannot be attracted magnetically, such as stainless steel or engineering plastics. These non-ferrous screws cannot be attracted by the holding member, and cannot be coupled securely on the holding chuck of the conventional pneumatic tools.

### SUMMARY OF THE INVENTION

Therefore the primary object of the present invention is to provide a holding chuck for fastening tools that has a spindle with one end coupling with a fastening tool to receive rotational transmission and another end coupling with a screw head of a screw to perform fastening or unfastening. The spindle is coupled with a hollow holding member on the periphery. The holding member has an indented dome on the bottom to attract magnetically the screw head. The invention further has features that include a plurality of spherical wedge elements wedged in an annular wall of the dome, and an elastic ring to confine the outer wall of the wedge elements so that the wedge elements press the screw head firmly on the holding chuck. Thereby the holding chuck can hold magnetic and non-magnetic screws.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional holding chuck of fastening tools.

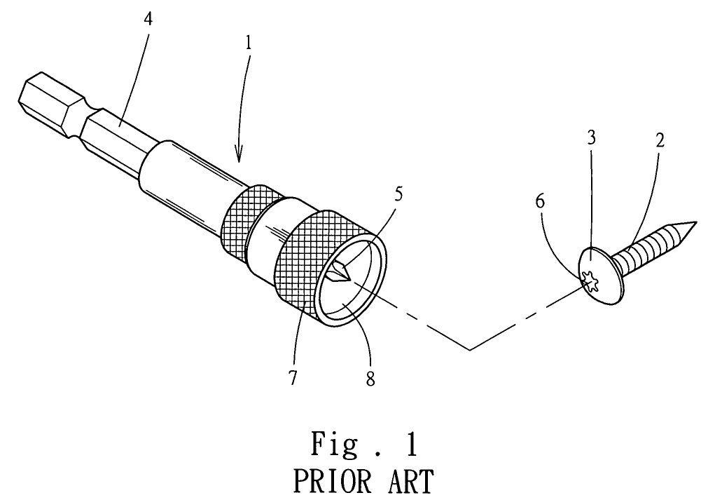

FIG. 2 is a sectional view of a conventional holding chuck of fastening tools.

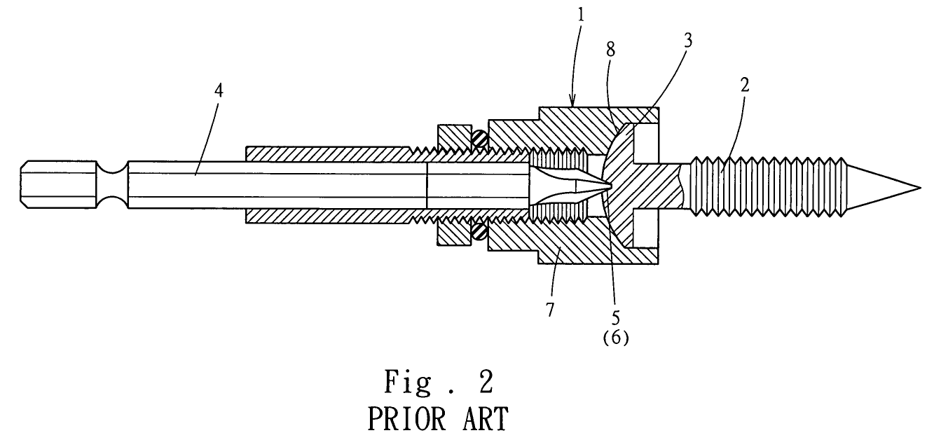

FIG. 3 is a perspective view of an embodiment of the present invention.

FIG. 4A is a sectional view of an embodiment of the present invention.

FIG. 4B is a schematic view according to FIG. 4A for holding a screw.

### DETAILED DESCRIPTION OF THE PREFERRED EMBODIMENT

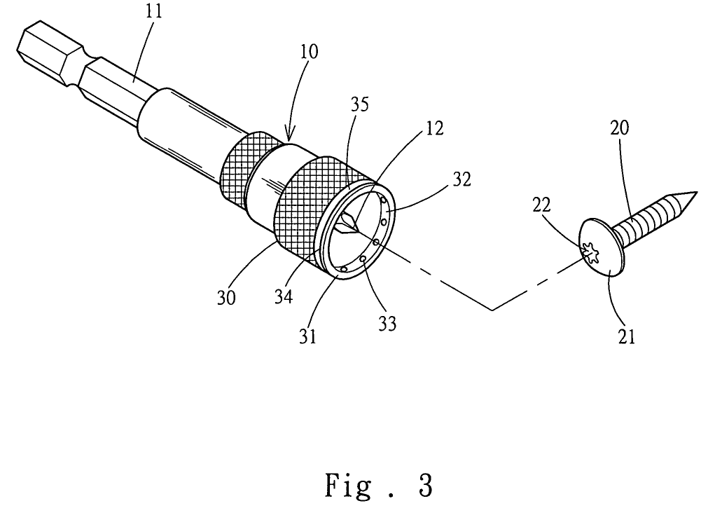

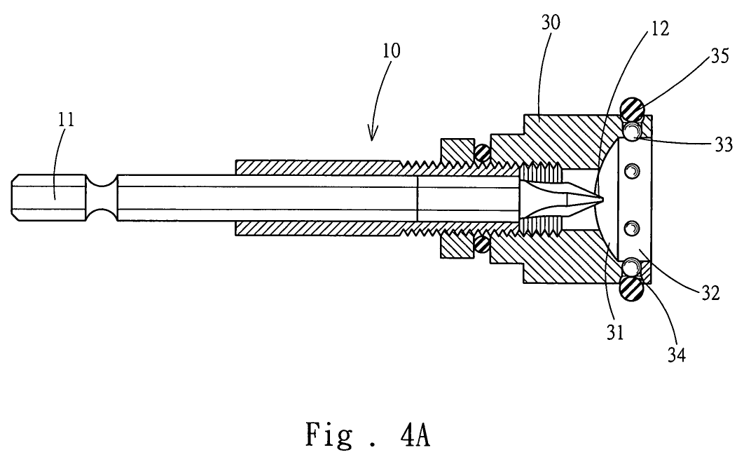

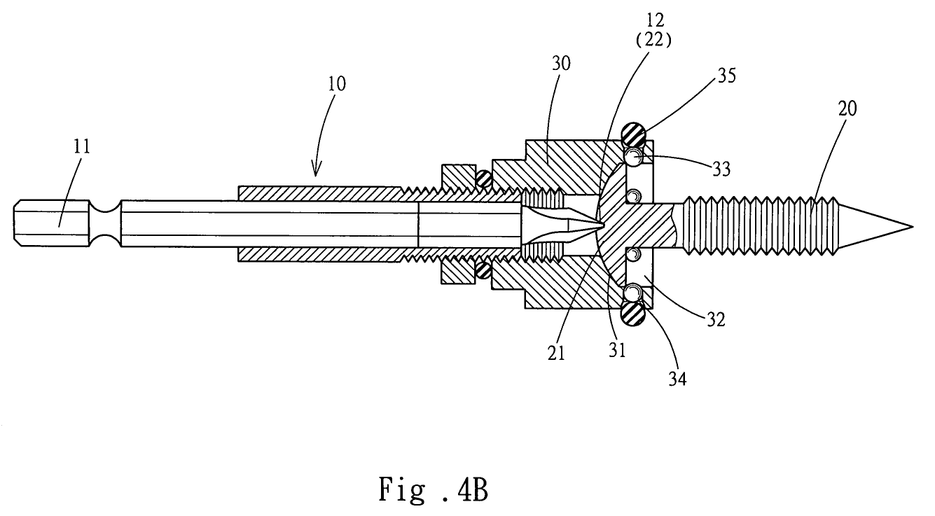

Please referring to FIGS. 3 and 4A, the holding chuck 10 for fastening tools according to the invention includes a hexagonal spindle 11 which has a first end coupled with a fastening tool (not shown in the drawings) to receive driving rotation and a second end formed a cross-shaped coupling section 12. The coupling section 12 is to couple with a screw head 21 of a screw 20. The screw head 21 has a plum-shaped notch 22 on the top surface to be coupled with the coupling section 12 to fasten or unfasten the screw 20. The spindle 11 is coupled with a hollow holding member 30 on the periphery. The holding member 30 has an indented dome 31 surrounding a second end of the spindle 11. The dome 31 has a magnetic top surface to attract the screw head 21 formed in a mating shape. The dome 31 further has an annular wall 32 formed on a lower side vertically. The annular wall 32 holds a plurality of spherical wedge elements 33 which are extended into the dome 31. The holding member 30 has an annular retaining groove 34 on the periphery coupled with an elastic ring 35. The elastic ring 35 retracts the outer side of the wedge elements 33 and pushes the wedge elements 33 inwards constantly.

By means of the aforesaid structure, when in use for holding the screw 20, referring to FIG. 4B, the coupling section 12 on the second end of the spindle 11 is inserted in the plum-shaped notch 22 of the screw head 21, the dome 31 covers the screw head 21 of the same shape so that the inner top surface of the dome 31 can attract the screw head 21 made of ferrous material, and the screw 20 does not escape and can be fastened or unfastened smoothly. The wedge elements 33 on the annular wall 32 of the holding member 30 are pushed outwards when the screw head 21 is inserted and coupled. The elastic ring 35 generates a retracting force to move the wedge elements 33 radially inwards to press the screw head 21. Hence the screw 20 made of ferrous material, besides being attracted by the top surface of the dome 31, also is held by the wedge elements 33, thus can be held securely in the coupling member 30. In the event that the screw 20 is made of stainless steel or engineering plastics, and is non-magnetic, the screw head 31 is held and coupled firmly by the wedge elements 33 due to the retracting force of the elastic ring 35, thus the screw 20 can be coupled with the spindle 11 securely without escaping.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A holding chuck for fastening tools, comprising:
a spindle located in the center of the holding chuck having a first end to couple with a fastening tool to receive a rotational driving force and a second end forming a coupling section, the coupling section being coupled with a screw head of a screw; and
a holding member coupled on the spindle having an indented dome on the bottom, the dome surrounding the second end of the spindle and having a magnetic inner top wall to couple with the screw head;
wherein the dome has an annular wall on a lower side to hold a plurality of wedge elements, the wedge elements being extended inwards through the annular wall, the annular wall having a retaining groove on an outer side to be coupled with an elastic ring.

2. The holding chuck for fastening tools of claim 1, wherein the spindle is hexagonal, the coupling section on the second end is formed in a cross-shape to be coupled with a plum-shaped notch formed on the screw head.

3. The holding chuck for fastening tools of claim 1, wherein the wedge elements are spherical.
